(19) United States
(12) Patent Application Publication
(10) Pub. No.: US 2008/0077802 A1
(43) Pub. Date: Mar. 27, 2008

(54) FUEL CARTRIDGE AUTHENTICATION

(75) Inventors: Robert David Richardson, Danville, CA (US); Ian W. Kaye, Livermore, CA (US); Chiko Fan, San Jose, CA (US); Theodore Prescop, Mountain View, CA (US)

Correspondence Address: BEYER WEAVER LLP, P.O. BOX 70250, OAKLAND, CA, 94612-0250, US

(73) Assignee: ULTRACELL CORPORATION, Livermore, CA (US)

(21) Appl. No.: 11/834,551

(22) Filed: Aug. 6, 2007

Related U.S. Application Data
(63) Continuation-in-part of application No. 11/316,199, filed on Dec. 21, 2005.
(63) Continuation-in-part of application No. 10/877,766, filed on Jun. 25, 2004.
(60) Provisional application No. 60/638,421, filed on Dec. 21, 2004.
(60) Provisional application No. 60/677,424, filed on May 2, 2005.
(60) Provisional application No. 60/682,598, filed on May 18, 2005.
(60) Provisional application No. 60/482,996, filed on Jun. 27, 2003.
(60) Provisional application No. 60/483,416, filed on Jun. 27, 2003.
(60) Provisional application No. 60/483,415, filed on Jun. 27, 2003.
(60) Provisional application No. 60/836,858, filed on Aug. 9, 2006.

(51) Int. Cl. H04L 9/32; H01M 8/04; B01D 21/30

(52) U.S. Cl. 713/189; 429/22; 726/21

(57) ABSTRACT

Described herein are systems and methods that test authentication information on a fuel cartridge. A controller on a device that interfaces with the cartridge tests and validates the authentication information before permitting fuel provision from the cartridge. The authentication information can be used to prevent unauthorized cartridges from providing fuel. This permits the device to ensure that the cartridge, its manufacturer, and/or its contents are acceptable. Authentication information stored in a cartridge memory may also be encrypted.

### CROSS-REFERENCE TO RELATED APPLICATIONS

This application a) claims priority under 35 U.S.C. §119(e) to i) U.S. Provisional Patent Application No. 60/836,858 filed on Aug. 9, 2006;
b) claims priority under 35 U.S.C. §120 and is a continuation in part of co-pending U.S. patent application Ser. No. 11/316,199, filed Dec. 21, 2005, which claimed priority under 35 U.S.C. §119(e) to: i) U.S. Provisional Patent Application No. 60/638,421 filed on Dec. 21, 2004, ii) U.S. Provisional Patent Application No. 60/677,424 filed on May 2, 2005, and iii) U.S. Provisional Patent Application No. 60/682,598 filed on May 18, 2005; and
and c) claims priority under 35 U.S.C. §120 and is a continuation in part of co-pending U.S. patent application Ser. No. 10/877,766, filed Jun. 25, 2004, which claimed priority under 35 U.S.C. §119(e) from i) U.S. Provisional Patent Application No. 60/482,996 filed on Jun. 27, 2003, ii) U.S. Provisional Patent Application No. 60/483,416 and filed on Jun. 27, 2003, and iii) U.S. Provisional Patent Application No. 60/483,415 and filed on Jun. 27, 2003; each of these patent applications identified above is incorporated by reference for all purposes.

### FIELD OF THE INVENTION

The present invention relates to fuel cartridges and fuel cell systems. In particular, the present invention relates to systems and methods that check the authenticity of information included with a fuel cartridge.

### BACKGROUND

Consumer electronics devices and other portable electrical applications still mainly rely on lithium ion and other battery technologies. Conventional batteries are heavy relative to their energy capacity.

Fuel cells offer an advance in portable electrical power. They offer higher energy densities, particularly when they use a liquid fuel. A fuel cell electrochemically combines hydrogen and oxygen to produce electricity. The ambient air readily supplies oxygen; hydrogen provision, however, calls for a working supply. A reformed hydrogen supply processes a fuel (or ‘fuel source’) to produce hydrogen. The fuel acts as a hydrogen carrier, is manipulated to separate hydrogen, and may include a hydrocarbon fuel, hydrogen bearing fuel stream, or any other hydrogen bearing fuel such as ammonia. Currently available hydrocarbon fuels include methanol, ethanol, gasoline, diesel, propane and natural gas. Liquid fuels offer high energy densities and the ability to be readily stored and transported.

Portable fuel cell systems are still not widely available to retail consumers. Neither are the fuel cartridges for these systems. Cartridge distribution remains an unmet need in the fuel cell industry.

### SUMMARY

The present invention relates to systems and methods that test authentication information on a fuel cartridge. A controller on a device that interfaces with the cartridge tests and validates the authentication information before permitting fuel provision from the cartridge to the device. The authentication information can be used to prevent unauthorized cartridges from providing fuel. This permits the device to ensure that the cartridge, its manufacturer, and/or its contents are acceptable. Authentication information stored in a cartridge memory may also be encrypted.

In one aspect, the present invention relates to a method of permitting fuel flow to a device that includes a fuel cell system. The method includes sending a challenge from a processor included with the device to a processor included with a fuel cartridge. The method also includes receiving, from the fuel cartridge, an encrypted response to the challenge. The method further includes submitting the encrypted response to a validation test. The method permits fuel flow from the fuel cartridge to the fuel cell system when the encrypted response to the challenge passes the validation test. The method denies fuel flow from the fuel cartridge to the fuel cell system when the encrypted response to the challenge does not pass the validation test.

In another aspect, the present invention relates to a method of interfacing a fuel cartridge with a device that includes a fuel cell. The method includes receiving, at a processor on the fuel cartridge, a challenge from a processor included in the device. The method also includes responding to the challenge using the processor on the fuel cartridge and an encryption key stored in a memory with the fuel cartridge. The method further includes sending an encrypted response to the challenge from the fuel cartridge to the device. The method additionally includes providing fuel to the device when the encrypted response to the challenge passes a validation test.

In yet another aspect, the present invention relates to a portable device for producing electrical energy. The portable device includes a fuel cell and a mating connector configured to interface with a cartridge connector included in a portable fuel cartridge to permit transfer of fuel from the portable fuel cartridge to the device. The portable device also includes a device processor, operating according to instructions stored in a memory, configured to: a) send a challenge from the device processor to a processor included with the fuel cartridge, b) receive, from the fuel cartridge, an encrypted response to the challenge, c) submit the encrypted response to a validation test, d) permit fuel flow from the fuel cartridge to the fuel cell system when the encrypted response to the challenge passes the validation test, and e) deny fuel flow from the fuel cartridge to the fuel cell system when the encrypted response to the challenge does not pass the validation test.

In still another aspect, the present invention relates to a portable cartridge for storing a fuel. The portable cartridge includes an internal cavity adapted to contain the fuel. The portable cartridge also includes a cartridge connector configured to couple to a mating connector on a device that includes a fuel cell system. The portable cartridge further includes a memory adapted to store encrypted information or a cartridge encryption key. The portable cartridge additionally includes a cartridge processor, operating according to instructions stored in a memory, configured to: i) receive a challenge from a processor included in the device that includes the fuel cell system, ii) respond to the challenge using the encrypted information or the cartridge encryption key, iii) send an encrypted response to the challenge from the fuel cartridge to the device, and iv) provide fuel to the device when the encrypted response to the challenge passes a validation test.

In another aspect, the present invention relates to a portable cartridge for storing a fuel. The portable cartridge includes a housing that includes an internal cavity and a bladder in the internal cavity adapted to contain the fuel. The portable cartridge also includes a cartridge connector configured to couple to a mating connector on a device that includes a fuel cell system. The portable cartridge further includes a memory and a cartridge processor inside the housing.

In still another aspect, the present invention relates to logic encoded in one or more tangible media for execution and, when executed, operable to control or operate a fuel cell system or its components according to one or more of the methods described herein.

These and other features of the present invention will be described in the following description of the invention and associated figures.

### BRIEF DESCRIPTION OF THE DRAWINGS

FIG. 1 shows a method for validating authentication information included with a cartridge in accordance with one embodiment.

FIG. 2 shows a method of validating authentication information included with a cartridge using cryptography techniques in accordance with a specific embodiment.

FIG. 3 illustrates a fuel cell system for producing electrical energy in accordance with one embodiment.

FIG. 4A shows a simplified cross section of a cartridge in accordance with one embodiment.

FIG. 4B illustrates a cartridge in accordance with another embodiment of the present invention.

FIG. 5 shows a cartridge with an automated ejection system and internal circuitry in accordance with another specific embodiment.

FIG. 6 shows the ejection and mechanical release of the cartridge of FIG. 5.

FIG. 7 shows a method for cartridge distribution that applies cartridge authentication in accordance with one embodiment.

### DETAILED DESCRIPTION OF THE PREFERRED EMBODIMENTS

The present invention is described in detail with reference to several embodiments as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The inventors have determined that an integrity problem looms for fuel distribution in the emerging portable fuel cell system marketplace. There are numerous sources of potential compromise. For example, fuel cells and fuel reformers are sensitive to stoichiometry: if the incoming fuel differs in composition from the intended fuel composition, e.g., the fuel differs in fuel/water ratio, includes unclean fuel with particulates that can damage a fuel cell and fuel reformer in the system, or is otherwise inadequate, then the portable fuel cell system may be permanently damaged. An unauthorized vendor of a fuel cartridge may not adhere to the fuel and cartridge standards that a fuel cell system manufacturer insists upon. Fuel from an unauthorized cartridge or cartridge manufacturer may thus damage the portable fuel cell system. Alternatively, the cartridge may include a substandard air filter for air entering the cathode in a fuel cell that permits particulates to enter the cathode. Other sources of compromise exist when the cartridge is intended for replaceable use while the system persists in lifetime longer than the usage of an individual cartridge. The inventors would like to help a fuel cell system manufacturer avoid such unauthorized and unreliable access to their system.

### Cartridge Authentication

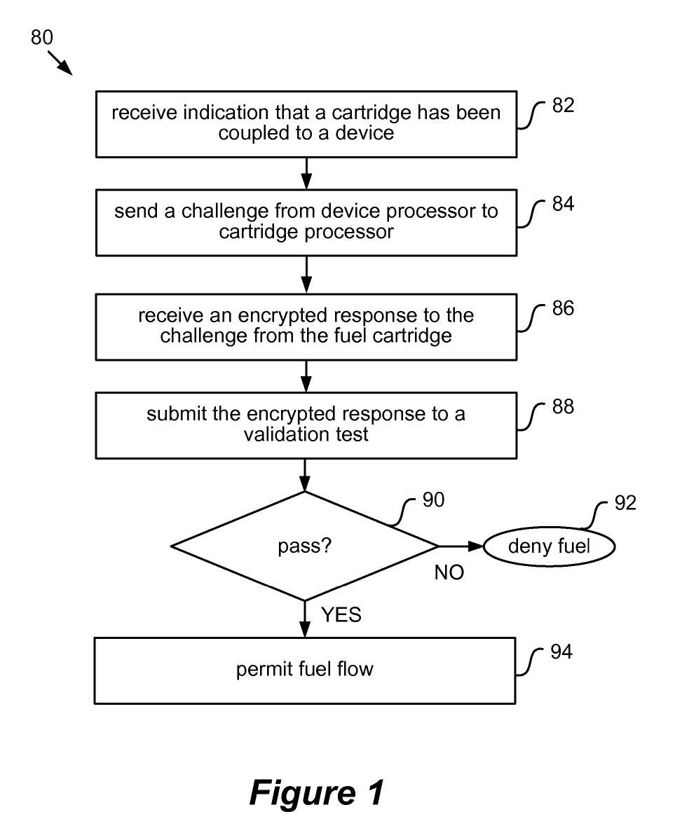

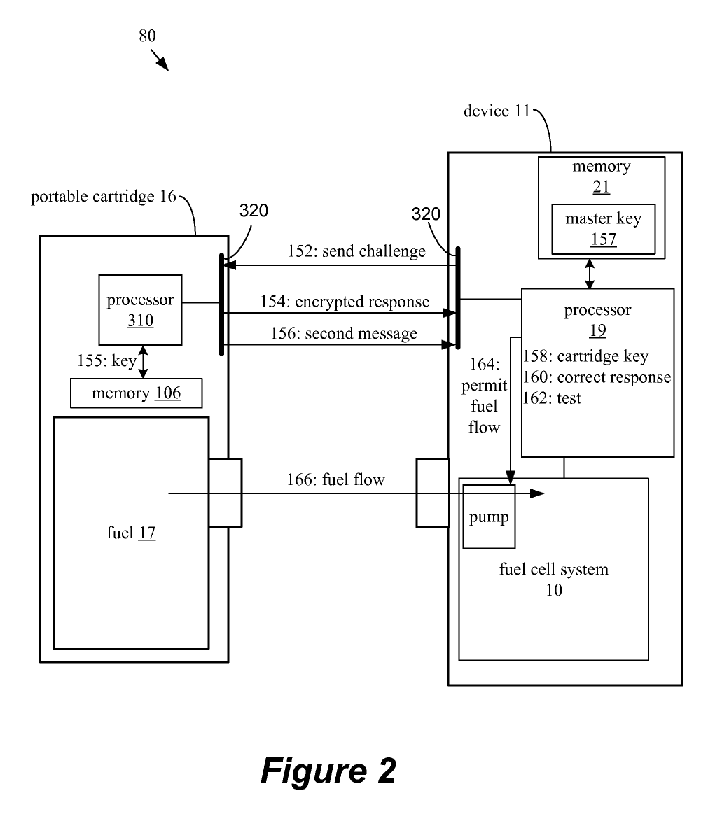

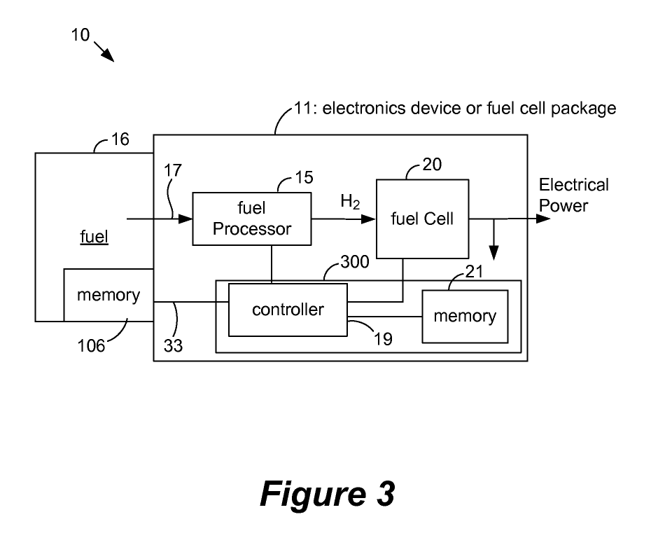

FIG. 1 shows a method 80 for validating authentication information included with a cartridge in accordance with one embodiment. While method 80 will now be described as a series of method steps, one of skill in the art will appreciate that the following description may also apply to a system and logic for permitting fuel flow. The system typically includes i) a device with a fuel cell and a device processor, such as a portable fuel cell system or a portable computer with a fuel cell contained therein, and ii) a portable fuel cartridge with a cartridge processor. One example of such a system shown in FIGS. 2 and 3.

Method 80 begins with receiving a cartridge at a device that includes a fuel cell or fuel cell system. The device processor then receives an indication that a cartridge has been coupled to the device (82). The device may include a sensor that a) detects cartridge presence when a cartridge has been mechanically coupled to the device and b) provides sensor output indicating cartridge presence. Alternatively, electrical contacts may provide a digital signal informing the device processor of cartridge presence.

The device processor then sends a challenge to a cartridge processor (84). In a specific embodiment, the challenge includes a random number, such as a 64 bit or 128 bit number. In another specific embodiment, the challenge includes a request for a password or other information that the device processor will use to validate cartridge authenticity. Both of these embodiments will be expanded upon below.

A properly configured cartridge includes a processor that provides a response to the challenge (86). In one embodiment, the cartridge processor sends, and the device processor receives, an encrypted response to the challenge. FIG. 2 describes authentication embodiments using various encryption techniques and encrypted responses suitable or use with method 80.

The device processor then submits the encrypted response to a validation test. In a specific embodiment, the challenge includes a request for a password or other specific information. In this case, the device processor reads the information returned to it by the cartridge processor and determines whether that information matches the correct answer. In another specific embodiment when the challenge includes a random number, and the number is modified by the cartridge processor, then the device processor checks the modified number for validation. For example, a cartridge processor may use encryption to alter the random number and provide a response that includes an encrypted random number. The device processor then encrypts the random number itself and compares its results to the result provided by the cartridge. Other validation tests can be used. Method 80 may include any suitable validation test or logic, as one of skill in the art will appreciate.

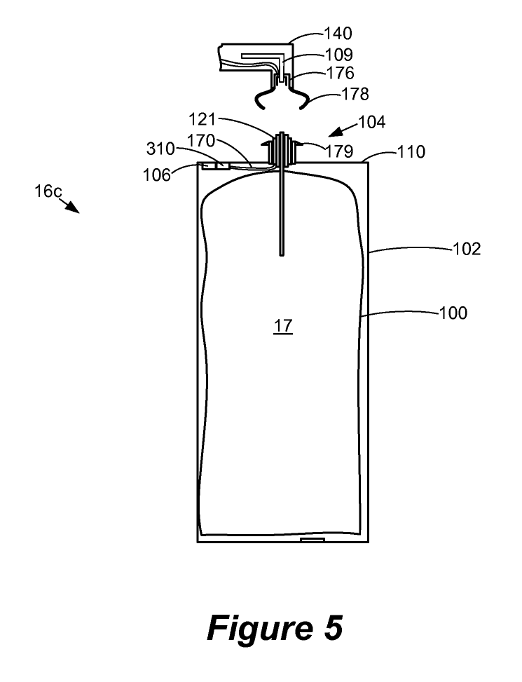

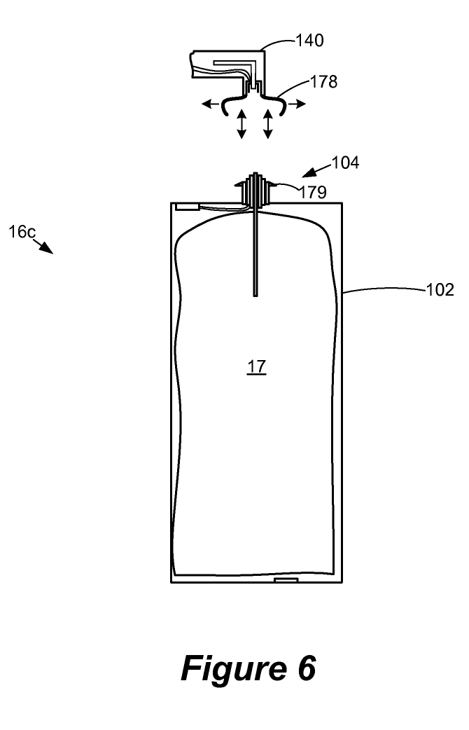

If the cartridge response does not pass the validation test, then the device processor denies fuel flow from the cartridge to the device (92). In addition, if the cartridge fails to return any response in 86, then the device processor denies fuel flow. A processor in the device may also take other steps when the encryption handshake and validation fails. In a specific embodiment, the device includes an automated ejection system configured to at least partially eject or detach the cartridge from the device. One suitable example of this is described below with respect to FIGS. 5 and 6.

When the cartridge response passes the validation test, the device processor then permits fuel flow from the cartridge to the device (94).

Validation of cartridge authentication information and techniques used herein to prevent an unauthorized cartridge from being used with a fuel cell system may rely on one or more cryptography techniques.

FIG. 2 shows a method 80 of validating authentication information using cryptography techniques in accordance with a specific embodiment. Method 80 is shown with a series of messages sent between a portable device 11 that includes a fuel cell system and a portable cartridge 16 coupled to the device. FIG. 2 separates device 11 and cartridge 16 for illustrative purposes, namely, to expand upon the messages sent between device 11 and cartridge 16. FIG. 3 shows one example of the two mechanically coupled together.

In one embodiment, method 80 uses symmetric cryptography techniques between the device processor and cartridge processor. Symmetric cryptography, also known as secret key cryptography, is a class of algorithms for cryptography that uses trivially related, often identical, cryptography keys for decryption and encryption. The encryption and decryption keys may be identical or trivially related through a transform that translates between the two keys. In one sense, the keys represent a shared secret between a cartridge and a device that can be used to maintain a private information link.

Method 80 may use stream ciphers or block ciphers. Stream ciphers encrypt the bits of the message one at a time, while block ciphers take a number of bits and encrypt them as a single unit. Blocks of 64 bits are suitable for use. In a specific embodiment, method 80 employs an advanced encryption system (AES), which is a block encryption system adopted by NIST. AES can use a 128-bit block size, and permits key sizes of 128, 192, and 256 bits.

In one embodiment, the fuel cell system device 11 has a “master key” per symmetric cryptography protocol (it is understood that a memory and/or processor associated with the fuel cell system actually stores the encryption key, however, for sake of discussion, it is easier to relate the fuel cell system device and its master key). The master key may be shared by multiple fuel cell systems for a particular manufacturer. This allows fuel cell systems for that particular manufacturer to only recognize cartridges that have been properly authorized according to its master key. Different master keys may then be assigned to different manufacturers to permit selective cartridge authentication for the different manufacturers.

In this master key embodiment, cartridge 16 has a secret key per symmetric cryptography protocol (again, it is understood that a memory and/or processor associated with the cartridge actually stores the encryption key, however, for sake of discussion, it is easier to directly relate the cartridge and its encryption key). In a specific embodiment, a secret key for the cartridge is derived by encrypting a serial number for the cartridge with the fuel cell system 10 master key. The serial number refers to any unique number, password, or code that uniquely identifies cartridge 16.

The serial number and/or secret key may change to increase cartridge integrity. For example, each time a cartridge is refilled by an authorized refiller, it may be loaded with a new serial number and/or secret key. Changing the serial number changes the secret key. This prevents an unauthorized cartridge distributor from obtaining a secret key for one cartridge and using that secret key in unauthorized cartridges.

Returning to FIG. 2, when the cartridge 16 is coupled to device 11, or when the cartridge is detected by the device processor 19 (e.g., via wireless means before coupling), the processor in device 11 verifies the authentication information in cartridge 16.

First, processor 19 creates a random challenge 104, such as a 128 bit word. The processor sends the challenge to cartridge 16 in a message 152.

In a specific embodiment, processor 310 in cartridge 16 receives the challenge and encrypts the challenge using its secret key and AES to create an encrypted response to the challenge. As mentioned above, cartridge 16 may include its own and unique secret key, which creates a unique response to the challenge.

Processor 310 in cartridge 16 then sends a message 154 back to device 11 that includes the encrypted response.

In the same message 154, or a second message 156 as shown in FIG. 2, processor 310 also sends its serial number to device 11.

Device 11 and cartridge 16 may communicate using any suitable electronic or digital technique. In a specific embodiment, the two communicate using wireless means. As shown, device 11 and cartridge 16 each include electrical leads 320 configured to contact each other when cartridge 16 mechanically couples to device 11. One suitable example of electrical contacts is described further below with respect to FIG. 5. Other physically linked and wireless communication arrangements are suitable for use herein.

Processor 19 in device 11 then tests the encrypted authentication information provided to it by cartridge 16. First, the fuel cell system processor uses its master key to encrypt the cartridge serial number (sent to device 11 in message 156) to reproduce the cartridge 16 secret key 155. In a specific embodiment, processor 19 uses the AES algorithm to reproduce the cartridge 16 secret key.

Processor 19 in device 11 then determines a correct encrypted response 160 to the challenge it created (and sent to cartridge 16). It does so by encrypting the challenge, e.g., the 128 bit number, with the cartridge's secret key 158—as determined by the processor 19 using its own master key and the cartridge serial number.

Processor 19 then tests cartridge authenticity 162 with a comparison between a) the encrypted response that it received from cartridge 16 in message 156 and b) the correct encrypted response 160 that it derived using the private key that a calculated (using its own master key and the serial number for the cartridge).

If the validation test 162 passes, a command 164 is sent to permit fuel flow. In the embodiment shown, fuel cell system 10 includes a pump that draws fuel 17 from cartridge 16. In another embodiment, cartridge 16 is pressurized and system 10 includes a valve that is normally closed, but opened using a command signal to permit fuel flow 166 to system 10.

If the verification in test 162 fails, then processor 19 rejects cartridge 16 and may issue an error message.

In another specific embodiment, when cartridge 16 is initially manufactured, or when it is refilled, it is initialized with a new serial number and a new cryptographic key. When the cryptographic key is computed from a serial number assigned to the cartridge using the fuel cell system 11 master key, this may require the authorized manufacturing or refilling station to have a copy of the fuel cell system master key. Alternatively, the manufacturing or refilling station may be provided with pre-computed cryptographic pairs, where each pair consists of one cartridge serial number and the corresponding cartridge cryptographic key, to avoid distributing the device 11 master key.

To prevent the same cartridge serial number from being used multiple times or copied by an unauthorized cartridge entity trying to produce unauthorized cartridges that access device 11, device 11 may keep track of each cartridge serial number that it receives fuel from, along with a log of fuel levels for that cartridge. Device 11 may then use logic and stored instructions to prevent any cartridge with the same serial number but greater fuel since its last usage from authentication and being used again. In other words, when the serial number for a cartridge is changed at refilling, if the same serial number shows up at a later time in a cartridge with more fuel, this later cartridge with a repeating serial number has been either filed or refilled by an unauthorized refiller using a duplicated serial number or refilled by an unauthorized refiner using the same cartridge but without refilling permission. This cartridge serial number logging prevents unauthorized behavior such as this.

Cartridge memory 106 may store the cartridge secret key 155 and/or cartridge serial number. In a specific embodiment, the cartridge key is stored in a secure and inaccessible memory on cartridge 16. For example, the cartridge manufacturer may physically blow a hardware fuse associated with a dedicated hardware memory; this subsequently makes it difficult or impossible to read data and from the dedicated memory. This is intended to make recovery of the cartridge key difficult and thwart an unauthorized source from recovering the cartridge key and duplicating unauthorized cartridges with a dubiously obtained cartridge key. The cartridge serial number need not be kept in a secure memory though. In a specific embodiment, method 80 transmits the cartridge serial number to system 11 using no encryption in message 156. In a specific embodiment, memory 106 includes at least a kilobyte of RAM. Larger sized memories may also be used.

Master key 157 is stored in device memory 21. Alternatively, master key 157 may be hidden to prevent a third-party from discovering the key and circumventing authentication measures described with respect to FIG. 2. For example, the master key may be locked up in firmware for a microcontroller included in the fuel cell system; a fuse in the microcontroller may be set to disable the ability to externally read the master key. Other security measures may be taken to hide the key in device 11.

If the device 11 is viewed as insecure (e.g., device 11 is portable computer and the memory bus is exposed, which would permit recovery of information from memory 21), then a second security processor may be included in device 11 or fuel cell system 10. This second processor might be the same type of processor used in cartridge 16, for example, which allows the code used in the cartridge 16 to implement AES to be re-used.

In another embodiment, method 80 uses asymmetric encryption techniques. Asymmetric encryption, also known as public key cryptography, is a form of cryptography that uses a pair of cryptographic keys—a public key and a private key. The private key is kept secret, while the public key is widely distributed. The keys are related mathematically, but the private key typically cannot be practically derived from the public key. A message encrypted with the public key can only be decrypted only with the corresponding private key.

Method 80 may use asymmetric encryption in one or more ways. First, it may use encryption keys to ensure confidentiality of information. Typically, a message or information encrypted with a public key cannot be decrypted without the corresponding private key. In a specific embodiment, information stored on memory 106 of cartridge 16 is encrypted using a public key assigned to cartridge 16. This means that only device 11 and its private key may access information stored on memory 106.

Second, method 80 may use asymmetric encryption to provide a digital signature and to ensure message authenticity. A message signed with a private key can be verified by anyone who has access to the associated public key, thereby verifying that the sender signed it and that the information has not been tampered with.

In one specific asymmetric embodiment, a device 11 or fuel cell system 10 has an encryption key organization where the fuel cell system stores a public key, which may be designated for multiple fuel cell systems of a manufacturer. This allows the fuel cell system, or multiple fuel cell systems for that manufacturer, to only recognize cartridges that have been encrypted with a signed message from an authorized cartridge having the corresponding private key. In this case, unscrupulous deconstruction of a fuel cell system and recovery of the public device 11 key will not provide any benefit. In particular, knowledge of the system 11 public key will not let an unauthorized entity digitally sign any messages, create any certificates, or produce authorized cartridges 16. The private key may be kept secret since it can be used to digitally sign certificates and authorization information that will be accepted by a device 11 or system 10.

In another specific asymmetric embodiment, each cartridge 16 has its own public-key/private-key pair. In this case, each time a cartridge is refilled by an authorized refiller, the cartridge memory is loaded with a new key pair and a certificate signed by the fuel cell system private key (or a private key for multiple fuel cell systems of a manufacturer or alliance). The certificate contents include the public key of the cartridge being refilled and the serial number of the cartridge. In this manner, each cartridge will have its own certificate (signed by the fuel cell system private key) which can be verified by any fuel cell system by using the corresponding fuel cell system public key, a copy of which is embedded in the fuel cell system.

FIG. 2 may be used to show an authentication method 80 using asymmetric encryption in accordance with another specific embodiment.

Method 80 begins by creating a random challenge, such as a 128-bit block. Processor 19 then sends a challenge message 152 from device 11 to cartridge 16.

Cartridge 16 responds to the challenge by digitally signing the challenge using an asymmetric private key 155. Processor 310 then sends its encrypted response back to system 11 in message 154.

Processor 310 also sends a second message 156 with its digital certificate, which authenticates the cartridge, to system 11.

System 11 then uses its copy of the public key to verify the certificate and thereby confirm cartridge 16 authenticity. System 11 also checks the encrypted response 154, produced in response to its challenge, by using the public key corresponding to the private key used to encrypt the response in message 154.

If the encrypted response sent in message 154 succeeds, and the digital certificate sent in second message 156 is authentic, then device 11 accepts the cartridge and permits fuel flow, and sends a message signaling such 164, if needed, to an appropriate component in the fuel cell system 10. If either test fails, then device 11 rejects the cartridge 16 and may issue an error message.

Similar to that described above, device 11 may keep track of each cartridge serial number that it receives fuel from, along with a log of fuel levels for that cartridge, to prevent the same cartridge serial number or asymmetric encryption certificate from being used multiple times or copied by an unauthorized cartridge entity trying to produce unauthorized cartridges.

A variety of asymmetric cryptographic techniques and systems are suitable for use herein. In a specific embodiment, an algorithm is selected to minimize overhead of creating an encrypted response by a processor in cartridge 16, so as to permit lower powered processor on the cartridge. When the cartridge is mass-produced, this saves cost. For example, the National Institute of Standards (NIST) Digital Signature Standard (DSS) has a low overhead for signing messages and is suitable for use. Other popular and computationally more expensive algorithms (e.g., RSA) are also suitable for use. As one of skill in the art will appreciate, computation time for the processor and encryption response will depend on specifics of the equations used and instruction set, such as the bit length of prime numbers, secret keys and words, etc.

The cartridge may also employ several techniques to reduce computational time in responding to an encrypted challenge. For example, signature generation for DSS often involves the signature of a message, M, as the pair of numbers r and s computed according to:
r=(gk mod p) mod q (1)
s=(k−1(SHA(M)+xr)) mod q. (2)

Equation (1) can be computed in advance to save response time. Thus, the cartridge 16 could pre-compute r and only perform the less demanding computation of s when prompted by device 11. Alternatively, method 80 can use symmetric key algorithms, which are generally less computationally intensive and faster than asymmetric key algorithms.

Cartridge 16 may also employ one or more techniques to reduce cartridge memory resources. For example, as shown, Equation (2) uses the Secure Hash Algorithm (SHA). SHA in the context of digital signatures reduces the size of an arbitrary message to 160 bits. Since this reduction is not needed for cartridge authentication, this computation can be omitted. SHA can be replaced with M, where M now designates the 160 bit challenge issued by the fuel cell system to the cartridge in message 152.

In addition to the cryptographic techniques described above, device 11 in cartridge 16 may also use other digital and cryptographic validation tests to verify authenticity of information on cartridge 16.

In one embodiment, device 11 requests a password or encrypted password from cartridge 16 with challenge message 152. The required password may be encrypted and stored in memory 106 on cartridge 16, thus removing the step of encrypting the data by processor 310. An authorized cartridge 16 then responds with the required encrypted password in response 154. The password may include any information, such as a fuel level last stored in memory on the cartridge by the same controller subsequently accessing the cartridge. In a specific embodiment, the password includes copyright material, such as a poem. The copyright material is then encrypted and stored in memory 106 on cartridge 16. The encrypted response 154 then includes the encrypted copyright material. Device 11 may test the validity of the encrypted copyright material in an encrypted form, or after decryption. Encryption this case may use a symmetric or asymmetric encryption system.

In another embodiment, device 11 performs one or more other tests before initiating fuel flow. In a specific embodiment, the device processor implements on/off control of a fuel cell system, or its parts, according to conditions around the fuel cell system. For example, the conditions may include sonic patterns around device 11. This is useful to prevent a fuel cell from operating while on-board an aircraft and unattended (e.g., in a cargo hold or briefcase). Current ICAO regulations do not permit a fuel cell to charge an electronics device or its batteries if the fuel cell and/or device are unattended. To remedy this issue, a fuel cell system may include a microphone to measure background noise. Periodically, control logic in the fuel cell system performs FFT or other signal processing on the microphone output to determine the frequency and sound pressure levels of the background noise. The control logic may also detect for one or more signatures in the background noise levels. If the spectra and/or SPL match those of an acoustic emission on an airplane, such as acoustic emission for an operating piston, turbofan, etc., then the control logic in the fuel cell system shuts down the fuel cell (in the absence of an override) and/or prevents fuel flow from the cartridge.

Also, combinations of the above-mentioned techniques may be used. For example, the system may prompt the cartridge for both a password with encrypted copyright material and an asymmetric encryption challenge as described above.

### Fuel Cell Systems

FIG. 3 illustrates a fuel cell system 10 for producing electrical energy in accordance with one embodiment. As shown, ‘reformed’ hydrogen system 10 includes a fuel processor 15 and fuel cell 20 contained in a portable electronics device or fuel cell system package 11. A fuel cartridge, or ‘storage device’, 16 couples to a device 11. System 10 processes a fuel 17 to produce hydrogen for fuel cell 20.

Storage device, or cartridge, 16 stores a fuel 17, and may comprise a refillable and/or disposable device. Either design permits recharging capability for system 10 by swapping a depleted cartridge for one with fuel. A connector on cartridge 16 interfaces with a mating connector on device 11 to permit fuel transfer from the cartridge. In a specific embodiment, cartridge 16 includes a bladder that contains the fuel 17 and conforms to the volume of fuel in the bladder. An outer rigid housing of device 16 provides mechanical protection for the bladder. The bladder and housing permit a wide range of portable cartridge sizes with fuel capacities ranging from a few milliliters to several liters. In one embodiment, the cartridge is vented and includes a small hole, single direction flow valve, hydrophobic filter, or other aperture to allow air to enter the fuel cartridge as fuel 17 is consumed and displaced from the cartridge.

A pressure source moves fuel 17 from storage device 16 to fuel processor 15. In a specific embodiment, a pump in system 10 draws fuel from the storage device. Cartridge 16 may also be pressurized with a pressure source such as a compressible foam, spring, or a propellant internal to the housing that pushes on the bladder (e.g., propane or compressed nitrogen gas). In this case, a control valve in system 10 regulates fuel flow. Other fuel cartridge designs suitable for use herein may include a wick that moves a liquid fuel from within cartridge 16 to a cartridge exit. If system 10 is load following, then a sensor meters fuel delivery to processor 15, and a control system in communication with the sensor regulates the fuel flow rate as determined by a desired power level output of fuel cell 20.

Fuel 17 acts as a carrier for hydrogen and can be processed or manipulated to separate hydrogen. The terms ‘fuel’, ‘fuel source’ and ‘hydrogen fuel source’ are interchangeable herein and all refer to a fluid (liquid or gas) that can be manipulated to separate hydrogen. Liquid fuels 17 offer high energy densities and the ability to be readily stored and shipped. Fuel 17 may include any hydrogen bearing fuel stream, hydrocarbon fuel or other source of hydrogen such as ammonia. Currently available hydrocarbon fuels 17 suitable for use with system 10 include gasoline, C₁ to C₄ hydrocarbons, their oxygenated analogues and/or their combinations, for example. Other fuel sources may be used with system 10, such as sodium borohydride. Several hydrocarbon and ammonia products may also be used.

Fuel 17 may be stored as a fuel mixture. When the fuel processor 15 comprises a steam reformer, for example, storage device 16 includes a fuel mixture of a hydrocarbon fuel and water. Hydrocarbon fuel/water mixtures are frequently represented as a percentage of fuel in water. In one embodiment, fuel 17 comprises methanol or ethanol concentrations in water in the range of 1-99.9%. Other liquid fuels such as butane, propane, gasoline, military grade “JP8”, etc. may also be contained in storage device 16 with concentrations in water from 5-100%. In a specific embodiment, fuel 17 comprises 67% methanol by volume.

Fuel processor 15 receives methanol 17 and outputs hydrogen. In one embodiment, a hydrocarbon fuel processor 15 heats and processes a hydrocarbon fuel 17 in the presence of a catalyst to produce hydrogen. Fuel processor 15 comprises a reformer, which is a catalytic device that converts a liquid or gaseous hydrocarbon fuel 17 into hydrogen and carbon dioxide. As the term is used herein, reforming refers to the process of producing hydrogen from a fuel 17. Fuel processor 15 may output either pure hydrogen or a hydrogen bearing gas stream (also commonly referred to as ‘reformate’).

Various types of reformers are suitable for use in fuel cell system 10; these include steam reformers, auto thermal reformers (ATR) and catalytic partial oxidizers (CPOX) for example. A steam reformer only needs steam and fuel to produce hydrogen. ATR and CPOX reformers mix air with a fuel/steam mixture. ATR and CPOX systems reform fuels such as methanol, diesel, regular unleaded gasoline and other hydrocarbons. In a specific embodiment, storage device 16 provides methanol 17 to fuel processor 15, which reforms the methanol at about 280 degrees Celsius, or less, and allows fuel cell system 10 usage in low temperature applications.

Fuel cell 20 electrochemically converts hydrogen and oxygen to water, generating electrical energy (and sometimes heat) in the process. Ambient air readily supplies oxygen. A pure or direct oxygen source may also be used. The water often forms as a vapor, depending on the temperature of fuel cell 20. For some fuel cells, the electrochemical reaction may also produce carbon dioxide as a byproduct.

In one embodiment, fuel cell 20 is a low volume ion conductive membrane (PEM) fuel cell suitable for use with portable applications and consumer electronics. A PEM fuel cell comprises a membrane electrode assembly (MEA) that carries out the electrical energy generation and electrochemical reaction. The MEA includes a hydrogen catalyst, an oxygen catalyst, and an ion conductive membrane that a) selectively conducts protons and b) electrically isolates the hydrogen catalyst from the oxygen catalyst. One suitable MEA is model number CELTEC P1000 as provided by BASF Fuel Cells of Frankfurt, Germany. A hydrogen gas distribution layer may also be included; it contains the hydrogen catalyst and allows the diffusion of hydrogen therethrough. An oxygen gas distribution layer may also be included; it contains the oxygen catalyst and allows the diffusion of oxygen and hydrogen protons therethrough. Typically, the ion conductive membrane separates the hydrogen and oxygen gas distribution layers. In chemical terms, the anode comprises the hydrogen gas distribution layer and hydrogen catalyst, while the cathode comprises the oxygen gas distribution layer and oxygen catalyst.

In one embodiment, a PEM fuel cell includes a fuel cell stack having a set of bi-polar plates. In a specific embodiment, each bi-polar plate is formed from a thin single sheet of metal that includes channel fields on opposite surfaces of the metal sheet. Thickness for these plates is typically below about 5 millimeters, and compact fuel cells for portable applications may employ plates thinner than about 2 millimeters. The single bi-polar plate thus dually distributes hydrogen and oxygen; one channel field distributes hydrogen while a channel field on the opposite surface distributes oxygen. In another embodiment, each bi-polar plate is formed from multiple layers and includes more than one sheet of metal. Multiple bi-polar plates can be stacked to produce the ‘fuel cell stack’ in which a membrane electrode assembly is disposed between each pair of adjacent bi-polar plates. Gaseous hydrogen distribution to the hydrogen gas distribution layer in the MEA occurs via a channel field on one plate while oxygen distribution to the oxygen gas distribution layer in the MES occurs via a channel field on a second plate on the other surface of the membrane electrode assembly.

In electrical terms, the anode includes the hydrogen gas distribution layer, hydrogen catalyst and a bi-polar plate. The anode acts as the negative electrode for fuel cell 20 and conducts electrons that are freed from hydrogen molecules so that they can be used externally, e.g., to power an external circuit or stored in a battery. In electrical terms, the cathode includes the oxygen gas distribution layer, oxygen catalyst and an adjacent bi-polar plate. The cathode represents the positive electrode for fuel cell 20 and conducts the electrons back from the external electrical circuit to the oxygen catalyst, where they can recombine with hydrogen ions and oxygen to form water.

In a fuel cell stack, the assembled bi-polar plates are connected in series to add electrical potential gained in each layer of the stack. The term ‘bi-polar’ refers electrically to a bi-polar plate (whether mechanically comprised of one plate or two plates) sandwiched between two membrane electrode assembly layers. In a stack where plates are connected in series, a bi-polar plate acts as both a negative terminal for one adjacent (e.g., above) membrane electrode assembly and a positive terminal for a second adjacent (e.g., below) membrane electrode assembly arranged on the opposite surface of the bi-polar plate.

In a PEM fuel cell, the hydrogen catalyst separates the hydrogen into protons and electrons. The ion conductive membrane blocks the electrons, and electrically isolates the chemical anode (hydrogen gas distribution layer and hydrogen catalyst) from the chemical cathode. The ion conductive membrane also selectively conducts positively charged ions. Electrically, the anode conducts electrons to a load (electrical energy is produced) or battery (energy is stored). Meanwhile, protons move through the ion conductive membrane. The protons and used electrons subsequently meet on the cathode side, and combine with oxygen to form water. The oxygen catalyst in the oxygen gas distribution layer facilitates this reaction. One common oxygen catalyst comprises platinum powder thinly coated onto a carbon paper or cloth. Other catalysts are suitable for use. Many designs employ a rough and porous catalyst to increase surface area of the platinum exposed to the hydrogen and oxygen. A fuel cell suitable for use herein is further described in commonly owned patent application Ser. No. 11/120,643 and entitled “Compact Fuel Cell Package”, which is incorporated by reference in its entirety for all purposes.

Since the electrical generation process in fuel cell 20 is exothermic, fuel cell 20 may implement a thermal management system to dissipate heat. Fuel cell 20 may also employ a number of humidification plates (HP) to manage moisture levels in the fuel cell.

While system 10 will mainly be discussed with respect to PEM fuel cells, it is understood that system 10 may be practiced with other fuel cell architectures. One difference between fuel cell architectures is the type of ion conductive membrane used. In another embodiment, fuel cell 20 is phosphoric acid fuel cell that employs liquid phosphoric acid for ion exchange. Solid oxide fuel cells employ a hard, non-porous ceramic compound for ion exchange and may be suitable for use with embodiments described herein. Other suitable fuel cell architectures may include alkaline and molten carbonate fuel cells, for example.

In addition to the components shown in shown in FIG. 3, system 10 may also include other elements such as electronic controls, pumps and valves, system sensors, manifolds, heat exchangers and electrical interconnects useful for carrying out functionality of a fuel cell system 10. Further description of a fuel cell system suitable for use herein is further described in commonly owned patent application Ser. No. 11/120,643 and entitled “Compact Fuel Cell Package”, which was incorporated by reference above.

System 10 generates dc voltage, and is suitable for use in a wide variety of portable applications. Device 11 refers to any system or apparatus that contains a fuel cell or fuel cell system. For example, electrical energy generated by fuel cell 20 may power a notebook computer 11 or other portable electronics device. Device 11 may also be a stand-alone portable electrical generator 11 configured to output electrical power; such portable generators are suitable for use with military personnel and other applications where electrical energy is needed. Device 11 may be a stand-alone system, which is a single device 11 including a fuel cell that produces power as long as it has access to a) oxygen and b) hydrogen or a fuel such as a hydrocarbon fuel.

In one embodiment, system 10 provides portable, or ‘small’, fuel cell systems that are configured to output less than 200 watts of power (net or total). Fuel cell systems of this size are commonly referred to as ‘micro fuel cell systems’ and are well suited for use with portable electronics devices. In one embodiment, the fuel cell is configured to generate from about 1 milliwatt to about 200 Watts. In another embodiment, the fuel cell generates from about 5 Watts to about 60 Watts. One specific portable fuel cell package produces about 25 Watts or about 50 Watts, depending on the number of cells in a stack for fuel cell 20.

In addition to power capacity, portable fuel cell system 10 may also be characterized by its size or power density. Volume may characterize device 11, where the volume includes all components of the device 11, save the external storage device 16, whose size may change. In a specific embodiment, device 11 has a total volume less than about a liter. In a specific embodiment, a package for device 11 has a total volume less than about ½ liter. Greater and lesser package volumes may be used with device 11 and system 10.

Portable device 11 also includes a relatively small mass. In one embodiment, device 11 has a total mass less than about a 1 kilogram. In a specific embodiment, device 11 has a total volume less than about ½ liter. Greater and lesser masses are permissible.

Embodiments described herein also apply to logic and control schemes for controlling components of a portable fuel cell system. In one embodiment, the control scheme uses a combination of a processor and logic stored in a memory.

FIG. 3 shows one embodiment of an onboard control board 300 that includes a processor system with a processor 19 and memory 21. Processor 19 and memory 21 may be cumulatively referred to as a processing system.

Processor 19, or controller 19, is designed or configured to execute one or more software applications that control one or more components in system 10. In addition, processing system 19 may be designed or configured to execute software applications that allow control one or more components in system. Processor 19 may include any commercially available logic device known to those of skill in the art. For example, processor 19 may include a commercially available microprocessor such as one of the Intel or Motorola family of chips or chipsets, or another suitable commercially available processor. Processor 19 may digitally communicate with memory 21 via a system bus, which may comprise a data bus, control bus, and address bus for communication between processor 19 and memory 21.

Memory 21 also stores logic and control schemes for methods describer herein. The logic and control schemes may be encoded in one or more tangible media for execution and, when executed, operable to validate a cartridge 16 as described above or operate a fuel cell system. In one embodiment, the fuel cell system methods are automated. A user may initiate system operation by turning on a power button for the system, and all steps are automated until power production begins. Because such information and program instructions may be employed to implement the systems/methods described herein, the present invention relates to machine-readable media that include program instructions, state information, etc. for performing various operations described herein. Examples of tangible machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The invention may also be embodied in a carrier wave traveling over an appropriate medium such as airwaves, optical lines, electric lines, etc.

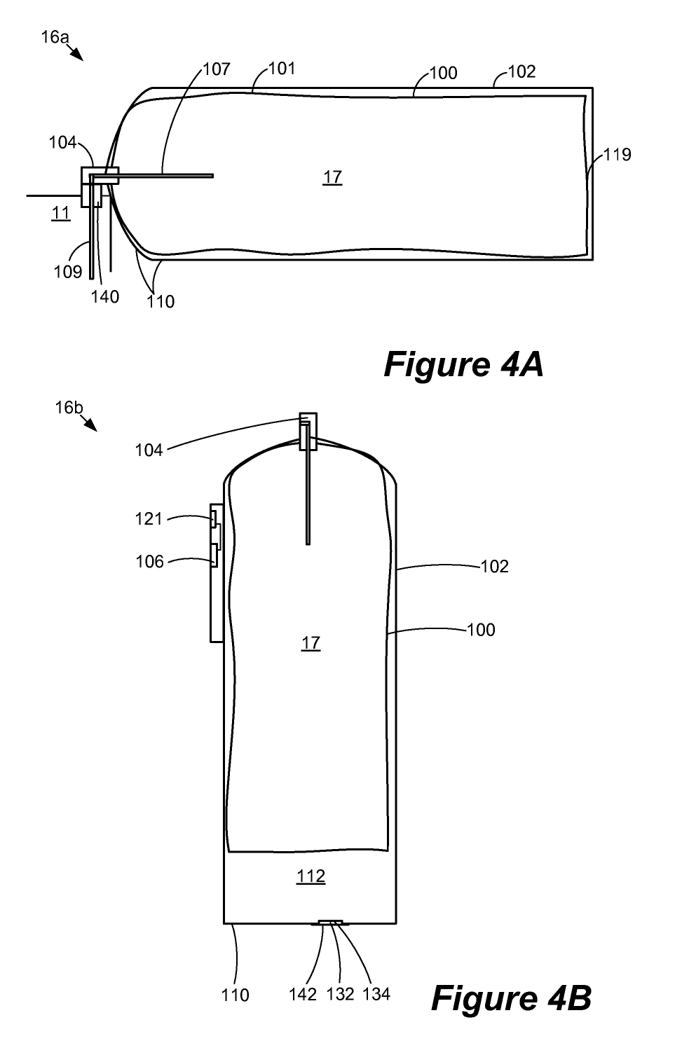

FIG. 4A shows a simplified cross section of a cartridge 16a in accordance with one embodiment. Cartridge 16a includes a bladder 100, housing 102 and connector 104.

Cartridge 16a stores fuel in a cavity internal to housing 102. In this instance, a bladder 100 contains fuel 17 and conforms to the volume of fuel in the bladder. In one embodiment, bladder 100 comprises a compliant structure that mechanically assumes a volume according to a volume of liquid stored therein. Compliant walls 101 of bladder 100, which stretch, expand and/or open when fluid is added to bladder 100, form the volume and contract and/or collapse fluid removal. In one embodiment, bladder 100 includes a sac that changes size and shape with the volume of liquid contained therein. A plastic, multi-layer sheet co-extruded, multi-layer sheet based material, rubber, latex or a metal such as nickel are suitable materials for use as walls 101 of bladder 100. In this case, walls 101 are compliant and change size with a changing liquid volume, and in some cases the walls allow for stretching with high fluid pressures in bladder 100. Walls 101 may also comprise a fire retardant plastic material. One suitable fire retardant plastic material for walls 101 is NFPA-701-99 Test 1 Polyethelyne as provided by Plasticare of Orange Park, Fla. In another embodiment, bladder 100 comprises a fixed cylinder and a piston that is pushed by a spring and moves in the cylinder to pressurize bladder 100 and displace volume according to used fuel.

A maximum volume 119 characterizes bladder 100 when the bladder fully expands. Maximum bladder volumes may vary with an application. In a specific embodiment, maximum volumes for cartridge 16a range from about 20 milliliters to about 4 liters. Maximum volumes from about 20 milliliters to about 800 milliliters are suitable for many portable electronics applications. A maximum volume of about 80 to about 500 milliliters is suitable for laptop computer usage and numerous portable applications. A 200 cubic centimeter volume is suitable for some portable applications. Some non-portable and extended run time systems may rely on storage devices 16a having up to 80 liters of maximum volume. The maximum volume for bladder 100 may differ from the fuel capacity of cartridge 16a. In some designs, cartridge 16a includes multiple bladders 100 that each contributes a maximum volume and cumulatively adds to a total fuel capacity for cartridge 16a. For example, a spare cartridge 16a intended for electronics power back up may contain two bladders 100 that each includes 300 milliliters of fuel 17.

Housing 102 provides mechanical protection for bladder 100 and any other components of storage device 16a included within housing 102. Housing 102 comprises a set of rigid walls 110 that contain bladder 100 and other internal components of cartridge 16a. In one embodiment, all components of cartridge 16a are contained within housing 102 save any portions of connector 104 that protrude out of the housing for interface with mating connector 140. In another embodiment, connector 104 is recessed within housing 102 and housing 102 provides an outer shell or assembly housing that defines outer bounds and shape of storage device 16a. Walls 110 collectively form an outer case or shell that substantially mechanically separates components internal to housing 102 from the external environment. Walls 110 also collectively form an interior cavity 112 (FIG. 4B). Interior cavity 112 is a space within storage device that contains bladder 100. Housing 102 is referred to herein as a ‘housing assembly’ when one or more rigid walls or parts are added to cartridge 16a and provide additional functionality other than just containment of internal components. Such functionality may include connectivity with a package, filtration of air going into a fuel cell system package, and holding one or more components of the cartridge such as a chip or an ambient atmospheric gas sensor that is configured to sense on or more gasses, such as CO, H₂ or O₂, for example.

Rigid walls 110 may comprise a suitably stiff material such as a plastic, metal (e.g., aluminum), polycarbonate, polypropylene, carbon fiber matrix, carbon composite material, etc. Rigid walls 110 may also be formed from a fire retardant material such as a fire retardant plastic material. One suitable fire retardant plastic material for walls 110 is 8-12% weight, JLS-MC mixed with PA66 Polyamide as provided by JLS Chemical of Pomona, Calif. Rigid walls 110 may be designed according to criteria for construction of thin walled pressure vessels. In this case, walls 110 and housing 102 may be designed to withstand a maximum pressure within bladder 100.

In one embodiment, housing 102 is integrally formed or manufactured to prevent disassembly of housing 102. In this case, walls 110 may be permanently attached (e.g., bonded and/or extruded from a common material) such that access into housing 102 is only gained through destruction of walls 110 and housing 102.

Connector 104 interfaces with a mating connector 140 included in device 11. Together, connector 104 and mating connector 140 permit transfer of fuel source 17 between bladder 100 and the external device 11. When mating connector 140 is included in a device that includes fuel processor, connector 104 and mating connector 140 interface to permit transfer of fuel 17 from cartridge 16a to the fuel processor, and through any intermediate plumbing between the two. Alternatively, when mating connector 140 is included in a hydrogen fuel source refiller, connector 104 and mating connector 140 interface to permit transfer of fuel 17 from the refiner to cartridge 16a. Interface between connector 104 and mating connector 140 may comprise any relationship and mating structures that permit fluid communication between the two connectors. In a specific embodiment, connector 104 includes a contact valve, which when depressed, permits fluid communication to and from bladder 100. In this case, connector 140 includes an o-ring or other suitable sealing and plumbing to interface with the contact valve and communicate fuel to or from cartridge 16a.

When mating connector 140 and connector 104 are mechanically coupled, a pump in device 11 and run by fuel cell system 10 draws fluid from bladder 100 into device 11. More specifically, fuel source 17 travels from bladder 100, through tube 107 and connector 104, into and through mating connector 140, and through tube 109 in device 11 to a fuel processor included therein.

Cartridge 16a and device 11, and or connector 104 and mating connector 140, may also include mechanical coupling to secure the interface, such as sliding interfaces and latching elements that bind connector 104 and mating connector 140 together until physically released.

In another embodiment, cartridge 16/device 11 compatibility employs a connector compatibility between connector 104 including cartridge 16 and mating connector 140 included in device 11. The connector compatibility may include designated connector shapes intended for certain fuel types and/or device manufacturers, for example. In this case, mechanical connectivity and/or fuel transfer between cartridge 16 and device 11 is conditional upon the connection compatibility. This thwarts unintended cartridges 16 from interfacing with device 11, and (vice versa) thwarts unintended devices 11 from interfacing with cartridge 16. For example, some cartridges 16 may include a fuel such as NaBh₄, which should not be provided to a DMFC or RMFC the fuel cell system. The connection compatibility requirements may restrict the device 11/cartridge 16 relationship according to one or more of: fuel type (e.g., similar to unleaded gas/ leaded gas nozzles at gas stations), fuel cell system type (RMFC, DMFC, etc.), cartridge 16 manufacturer, device 11 manufacturer (e.g., such as a certain set of laptop or electronics device manufacturers), fuel cell 20 manufacturer, fuel processor 15 manufacturer, date of manufacture, and/or fuel cell system generation, for example. Other restrictions are suitable for use with the present invention.

Connector compatibility may include a ‘keyed’ configuration that provides connection selectivity. For example, connector 104 may comprise a shape unique to a particular fuel (e.g., a circular adaptor for methanol). In this case, mating connector 140 offers an exclusive interface shape that only receives a connector 104 for a methanol based cartridge 16 with that shape. This keying system prevents the wrong fuel type from being installed in a device that cannot accept that fuel, e.g., gasoline bums at a higher temperature and may not be suitable for use in all methanol fuel processors. This keying system also prevents cartridge 16 from being refilled with the wrong hydrogen fuel source 17. Further description of connector compatibility is described in commonly owned and co-pending U.S. patent application Ser. No. 10/877,766, entitled “PORTABLE FUEL CARTRIDGE FOR FUEL CELLS”, which was incorporated by reference above. In addition, the present invention contemplates that adaptors may be used to have cartridges with incorrect connectors to be adapted to fit a certain keyed mating connector.

In another embodiment, cartridge 16/device 11 compatibility includes structural compatibility that requires the cartridge 16 housing to have a certain shape in order to physically interface with device 11. For example, device 11 may be a laptop computer and cartridge 16 is required to fit within a dc battery bay of the laptop computer. Alternatively, device 11 may include sliding and/or latching interfaces that require the cartridge to have mating sliding and/or latching interfaces in order to mechanically couple to device 11.

In one embodiment, one of connector 104 and mating connector 140 includes a ‘male’ designation and configuration while the other includes a ‘female’ designation and configuration. The male configuration includes portions of the connector that protrude, such as a valve, one or more pins or electrical leads. The female configuration includes portions of the connector that receive the male portions, such as receptacles that receive a contact valve, or holes arranged to receive the male electrical leads and permit electrical communication. The connector 104 on cartridge 16 may include a female configuration that recesses within housing 102. In this case, since it is recessed, connector 104 reduces the chances of being knocked off during handling.

Mating connector 140 may be disposed on a variety of devices. In one embodiment, mating connector 140 is disposed on a side portion of an OEM device (i.e. a laptop computer). In another embodiment, mating connector 140 is included in a portable fuel cell package. Further discussion of portable fuel cell packages suitable for use with the present invention are described in commonly owned patent application entitled “Compact Fuel Cell Package” and filed on May 2, 2005, which was incorporated by reference above. Mating connector 140 may also be included in a refilling device that includes hardware for refilling cartridge 16 with fuel source 17.

FIG. 4B illustrates a cartridge 16b in accordance with another embodiment of the present invention.

Cartridge 16b includes a memory 106, which stores information relevant to usage of cartridge 16b. In one embodiment, memory 106 includes a digital memory source that permits a controller to read and write from the digital memory. In this case, cartridge 16b includes electrical connectivity 121 for digital communication between memory 106 and a processor or controller on device 11. For example, connector 104 may include female electrical slots 121. A mating connector 140 (FIG. 4A) for connector 104 then includes male leads positioned and sized to fit into slots 121. The electrical leads 121 contact when the connectors 104 and 140 interface and enable electrical and digital communication between a controller in device 11 and memory 106.

Memory 106 also stores information for authentication of cartridge 16b. This may include a public/private key encryption number, encrypted copyright material, a number suitable for CRC algorithms, and other digital authentication information. A unique serial number or other identification assigned to cartridge 16b allows it to be exclusively identified. In one embodiment, the unique number is updated when cartridge 16b is refilled. A central database in communication with a refilling station then logs refilling information for cartridge 16b according to the unique number. The security and authentication information may also include an identification signature for cartridge 16b or the manufacturer of cartridge 16b. The authentication information may restrict cartridge 16b usage to: a) designated electronics devices and portable fuel cell packages, b) designated fuel cell types, c) designated fuel cell system types, d) designated fuel cell and/or fuel cell system manufacturers, e) designated devices such as laptops or electronics devices common to a specific manufacturer, etc.

In one embodiment, cartridge 16b is considered ‘smart’ since memory 106 stores information related to the performance, status and abilities of cartridge 16b. A digital memory or chip allows a controller on device 11 to read and write information relevant to usage of the cartridge 16b to memory 106. Reading from digital memory 106 allows reception and assessment of information in memory 106 to improve usage of cartridge 16b. For example, a computer that receives storage device 16 may inform a user that the storage device 16b is empty or how much fuel is left (or how much time on the system is available based on its power consumption and the amount of fuel remaining). Writing to a digital memory 106 allows information in memory 106 to be updated according to storage device 16 usage. Thus, if a user nearly depletes fuel 17 in cartridge 16b while powering a computer, the next user may be informed after the first computer writes an updated amount of fuel source 17 remaining in bladder 100 into memory 106.

Information stored in memory 106 that may not change with cartridge 16b usage and may comprise a) a fuel type stored in the cartridge 16b, b) a model number for cartridge 16b, c) manufacture date, and/or d) a volume capacity for bladder 100 or cartridge 16b. The model number of cartridge 16b allows it to be distinguished from a number of similar devices, and may also provide other logistical information to a controller such as an identity of the cartridge manufacturer.

Transient information stored in digital memory 106 may change according to the status and usage of cartridge 16b may include a) a current volume for fuel in the storage device, b) a number of refills when cartridge 16b is configured for re-usable service, c) the last refill date, d) the refilling service provider that refilled cartridge 16b, e) usage history according to a storage device identification, f) hydrogen fuel mixture information, and g) a model number for cartridge 16b.

The authentication information for cartridge 16b may be transient or fixed. For example, security features that protect the compatibility information may be updated each time the cartridge is refilled or used. Alternatively, the compatibility and/or authentication information may be fixed for the life of a cartridge.

Memory 106 may include any commercially available memory source, such as such as a non-volatile serial EEPROM memory chip. In a specific embodiment, memory 106 includes a model number bq26150 authentication chip as provided by Texas Instruments of Dallas, Tex. The bq26150 provides a method to authenticate fuel cartridges and information stored thereon as described below and ensures that only cartridges including predetermined compatibility information are used by a device that includes a fuel cell. The bq26150 uses a 96-bit unique device identification, a device unique 16-bit seed, and a 16-bit device specific CRC to provide cartridge authentication. In addition, the bq26150 stores other information such as an identification number for the cartridge, a CRC seed, and CRC polynomial coefficients. The information may also be stored with encryption to prevent open access to data.

The bq26150 also includes memory space to store information related to usage of the cartridge. For example, public OTP memory in the chip can be used as a fuel gauge. Each time that fuel is consumed, a fuel gauge in the memory is updated. In a specific embodiment, fuel is consumed in fixed increments and the memory uses a bit counter to track fuel usage. For example, fuel may be consumed at ‘x’ milliliter (e.g. 2 milliliter) increments and the memory moves to next bit each time the fuel increment is supplied. When ‘y’ bits have been incremented or programmed, x*y milliliters of fuel have been consumed. Known capacity for the cartridge then dictates when it is empty (e.g., a 200 ml is empty after 100 increments of 2 milliliters have been supplied). In a specific embodiment, when the cartridge is refilled, this chip is replaced when the memory includes a public OTP memory.

In another specific embodiment, memory 106 includes a commercially available memory source that is custom programmed. One suitable memory is part number DS2431 from Maxim Integrated Products of Dallas, Tex. This memory device has a 6 byte unique serial number installed by the manufacturer. This serial number may be used as a password as described above. In a specific embodiment, the serial number, a separate password, the fuel level within 50 ml, and 2 CRC bytes are all encrypted with a cartridge or system 128 bit key and the AES algorithm. The decrypted serial number and password are then used by methods described above to authenticate the cartridge. The fuel level of the cartridge, within about 1 milliliter for example, may also be stored on a memory 106 chip unencrypted and updated every 1 milliliter of fuel usage. When the encrypted fuel level is updated every 50 ml, a new CRC is calculated, encrypted with the key, and stored on memory 106. If the unencrypted fuel level is ever greater than the encrypted fuel level, then the cartridge is rejected as an unauthorized refill.

In another specific embodiment, memory 106 includes a so-called “memory spot chip” (MSC), such as those developed by Hewlett Packard (HP). This wireless data chip is similar to RFID tags but can store more data, transmit data faster, and can encrypt data. The data can also be erased and rewritten. A radio transmitter/receiver located on device 11 communicates with the MSC. Thus un-encrypted and/or encrypted one or two-way data transmission can occur between the fuel cartridge and the fuel cell system. Pertinent information such as manufacturing information (serial number, manufacture date etc.), performance information (remaining fuel level, type of fuel, system compatibility information, encrypted security features etc.), and authentication information can be stored on the cartridge and communicated back to the fuel cell system.

Cartridge 16b also includes one or more vents 132 in housing 102 that allow air to enter and exit in internal cavity 112 within housing 102 as bladder 100 changes in volume. Air vent 132 comprises one or more holes or apertures in a wall 110 of housing 102. In another embodiment, cartridge 16b does not include a vent in the cartridge housing 102 and relies on a vent included in a valve or connector 104 that provides fuel source communication into or out of the storage device.

A filter 134 spans the cross section of vent 132 and intercepts air passing through vent 132. In a specific embodiment, filter 134 includes a hydrophobic and gas permeable filter that prevents foreign materials from entering cartridge 16b. Materials blocked by filter 134 may include liquids and particles such as undesirable oils and abrasives. The hydrophobic filter also prevents fuel 17 from escaping housing 102 in the event that bladder 100 develops a leak. Filter 134 may comprise micro porous Teflon or another micro porous material such as Teflon coated paper. A sintered metal filter, for example one with a 3 micron pore size, may also be used. One suitable filter 134 includes micro porous “Gore Tex”Teflon as provided by WL Gore Associates of Elkton, Md. A mechanical shield 142 spans and covers vent 132 and prevents foreign bodies from entering housing 102 through vent 132.

Cartridge 16b may also include other features such as a pressure relief valve that limits pressure in the bladder or cartridge, a fuel filter that intercepts fuel 17 as it leaves bladder 100 and before it leaves connector 104, a fire retardant foam disposed in bladder 100, and a wireless identification (ID) tag for memory 106, for example. These and other features suitable for use with a cartridge of the present invention are described in commonly owned and co-pending U.S. patent application Ser. No. 10/877,766 and entitled “PORTABLE FUEL CARTRIDGE FOR FUEL CELLS”, which was incorporated by reference above.

Cartridges of the present invention may include one or more commercially available components. Using commercially available products allows the present invention to use mass produced, readily available, and proven technology. Off-the-shelf components may also reduce cartridge cost.

Aerosol cans, for example, are a proven technology suitable for use with housing 102 to store a hydrogen bearing fuel. Conventional aerosol containers are well suited for high-pressure capabilities, such as 200 psig and above. Conventional aerosol containers also include relatively high evacuation efficiency and may rely on commercially automated fueling equipment or fueling equipment and methods as described below. These devices often include commercially available components suitable for use in a cartridge such as: commercially available cartridge housings (also referred to as ‘canisters’ or ‘cans’), bladders, commercially available heads (or ‘mounting caps’) that attach to the canisters, nozzles, and so on. Many commercially available nozzles include contact valves that permit binary fluid communication with/without contact. One suitable supplier of aerosol products including canisters and contact nozzles is Precision Valve, Inc. of Yonkers, N.Y. Many such commercially available devices permit storage of liquids and fuels at high pressures. Some commercially available storage devices are capable of handling pressures up to and above 200 psi. Stronger commercially available storage devices handle pressures up to about 500 or 600 psi.

In a specific embodiment, the cartridge housing includes commercially available aluminum components that crimp and seal together. For example, the housing may include a top aluminum head portion (also referred to as a ‘mounting cup’) that crimps to a cylindrical aluminum housing (also referred to as a ‘can’). This advantageously seals the head to the cartridge housing. One or more components may be added internally to the aluminum cartridge housing before the seal is made. For example, a bladder may be added before the two parts are joined. The crimped connection then secures and seals the bladder.

A cartridge may include one or more of the following materials: polycarbonate, ABS, Nylon, PET, HDPE, or PCABS in housing 102; steel or aluminum or another suitably rigid metal or material in housing 102; tinplate/polypropylene/ nylon for a valve; and nylon or polypropylene for a bladder. Other materials may be used. The fuel cartridge may also include a commercially available 202 bag accessed using a commercially available aerosol valve. One of skill in the art is aware of the wide range of the aerosol can designs, bags and valves, and the fuel cartridge is not limited to any particular cartridge construction or design.

In one embodiment, a cartridge 16 includes memory 106 and processor 310 inside housing 102. FIG. 5 shows a cartridge 16c in accordance with another specific embodiment.

Cartridge 16c one includes memory chip 106 and processor 310 inside of housing 102. For example, memory 106 and processor 310 may be attached to the inside of a wall 110 in housing 102 using a suitable adhesive. Electrical wires 170 extend from and processor 310 inside housing 102 to electrical connector 104.

As shown, connector 104 includes electrical contacts 121 disposed about the perimeter of line 107, which together form a contact valve or nozzle for connector 104. Electrical contacts 121 include barrel type contacts that represent cylinders disposed about the line 107. The barrel type contacts 121 allow cartridge 16c to be vertically snapped into place to interface with mating connector 140. Electrical contacts 121 may include from 1 to 4 individual barrels, pins or lines, or more, as determined by an application. Half barrel contacts, or ring contacts, are also suitable for use. These contacts all permit rotational orientation. Other types of contacts 121 are also suitable for use, such as those that do not permit rotational orientation. In another specific embodiment, a valve cap 172 or housing 102 is used as an electrical contact when each part includes a metal.

In this case, mating connector 140 includes mating electrical contacts 176 configured to contact barrel contacts 121 when connector 104 and mating connector 140 mechanically couple together.

Spring-loaded clip 178 mechanically and detachably couples connector 140 connector 104 using a latch 179 on connector 104. Clip 178 and latch 179 permit quick connect and disconnect.

By placing memory chip 106 inside the housing 102, such as an aluminum can, and by placing electrical contacts 121 around a contact valve or nozzle, all connections between a cartridge 16 and device 11 can be placed on top of the cartridge, thereby permitting a smaller, lighter, and easier to manufacture cartridge.

In another specific embodiment, internal memory chip 106 includes wireless capabilities, thereby eliminating the need for wires and electrical connections. Thus, an RFID chip 106 is suitable for use and can be placed in the can. Several suitable RFID devices were described above.

Cartridge 16 may also include additional interfaces for coupling to device 11. The interfaces may include one or more of: a sliding interface between a cartridge and package, a latching interface that holds the cartridge in one or more positions relative to the package, and/or security features that prevent unintended detachment or attachment, for example.

As described above, device 11 may also take added steps when the encryption handshake and validation test fails. In a specific embodiment, device 11 includes an automated ejection system that at least partially ejects or detaches cartridge 16 from device 11. FIG. 5 also includes an electrically controlled disconnect in accordance with another specific embodiment.

The electrically controlled disconnect is configured to separate connector 104 and mating connector 140 in response to a digital or electrical signal. In a specific embodiment, spring-loaded clip 178 includes a nickel titanium shape memory alloy. The spring-loaded clip 178 then includes two states: a first state that mechanically holds connector 140 to connector 104, and a second state that permits movement between the two connectors and their respective devices. An electrical signal alters clip 178 between its two states, which permits an electrically actuated ejection. More specifically, when the alloy in clip 178 is cold and in the first state, cartridge 16 can be inserted with force based on the mating geometry of clip 178 and latches 179, but is then held by clip 178 and latches 179. To release cartridge 16, an electrical pulse is sent through the nickel titanium, changing its shape such that clip 178 and latches 179 decouple and the cartridge 16 is free to move relative to device 11. In a specific embodiment, a spring between the device 11 and cartridge 16 pushes cartridge 16 away from mating connector 140 or device 11. This also allows the device 11 control board to release cartridge 16 when empty, authentication fails, or if some other problem occurs.

In a specific embodiment, the Nickel Titanium shape memory alloy in clip 178 is configured to provide a threshold holding force. In some designs, the threshold holding force is large enough to hold cartridge 16 in place during normal movement and small drops (e.g., less than 1 meter), but release cartridge 16 during more extreme movement (e.g., greater than 1 meter drops). The size and weight of cartridge 16 may be used to determine the threshold holding force. In addition, shape of clip 178 may also be used to tailor the holding force provided by clip 178 when coupled to latch 179. The holding strength may be selected to permit manual release of the cartridge (with a manual force greater than the threshold holding force).

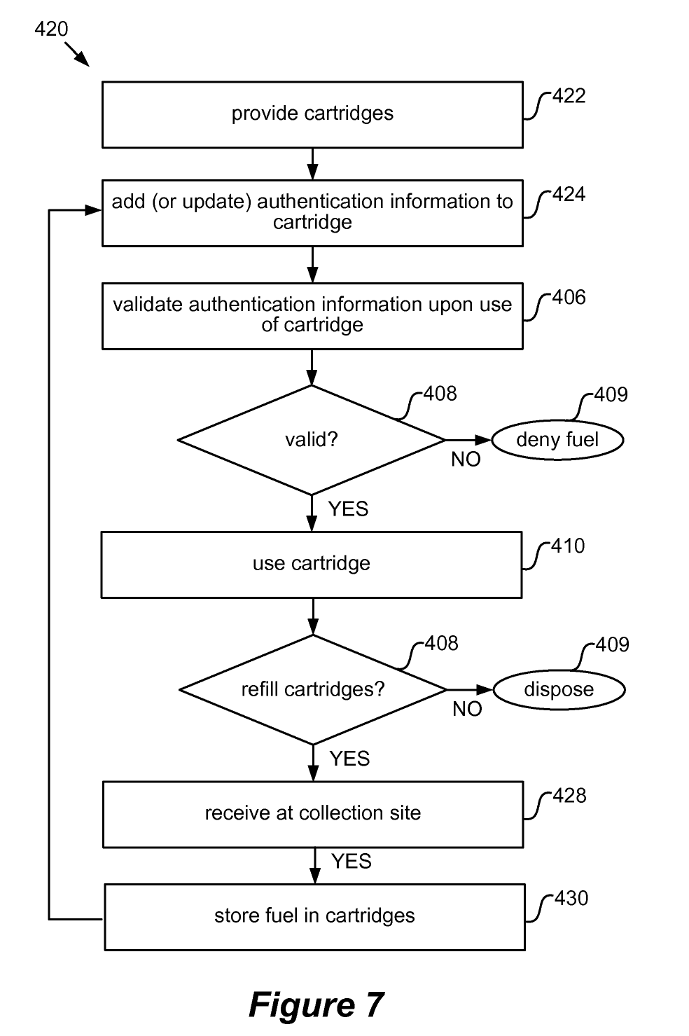

Cartridge authentication as described herein also improves cartridge distribution. FIG. 7 shows a method for cartridge distribution 420 that applies cartridge/device authentication in accordance with another embodiment.

Cartridge distribution 420 begins with providing fuel cartridges for use with portable fuel cell systems (422). This may be done by an initial manufacturer of hardware for the cartridges, a cartridge fuel supplier that stores fuel into the cartridges, and/or a sales entity that distributes or sells cartridges to consumers. Direct sales may include sales at retail outlets and mail order, for example. Indirect sales may include cartridge production at an OEM that supplies cartridges to an electronics device manufacturer, for example, that does not make its own cartridges but sells fuel cartridges for use with their electronics devices.

One of these entities adds authentication information to a cartridge that affects compatibility between fuel cartridges and devices that include a fuel cell and use a fuel cartridge (424). The authentication information reduces compatibility of a cartridge by restricting what devices the cartridge will provide fuel to and/or restricting what cartridges can provide fuel to a device.

Cartridge distribution according to distribution 420 thus permits flexible and customizable compatibility arrangements. Exclusivity may be established for cartridges and/or devices. Cartridge exclusivity limits which cartridges a device receives fuel from; device exclusivity restricts which devices a cartridge may provide fuel to.

Cartridge exclusivity allows a device manufacturer to validate authentication information and limit which cartridges and cartridge suppliers their device will accept fuel from. This permits the device manufacturer to invalidate cartridges according to fuel type, for example. Fuel cell systems are often designed to receive a single or limited set of fuels; a methanol fuel cell system (RMFC or DMFC) typically is not intended to receive an ammonia fuel for example. In addition, an RMFC or DMFC fuel cell system may require a particular fuel mixture. In instances such as these, authenticating cartridge compatibility protects the fuel cell system from receiving a fuel it was not intended to receive. Authentication in this manner permits a device manufacturer to limit who supplies cartridges for their devices to authorized and trusted suppliers.

Cartridge validation and exclusivity may also be selective amongst cartridge manufacturers. One specific distribution arrangement dispenses cartridges with authentication information that is local to one or more portable computer (or other electronics device) manufacturers. In this case, devices of a particular manufacturer check for authentication information included in approved cartridges to selectively authenticate which cartridges their devices use. This provides cartridge selectivity between cartridges that otherwise may be compatible (e.g., cartridges that include compatible features such as a suitable connector and fuel type). Selective authentication in this manner permits a device manufacturer to limit who supplies cartridges for their devices. The manufacturer then provides the compatibility and authentication information to cartridge manufacturers and distributors it approves, e.g., to ensure cartridge quality for its customers. Thus, the selective authentication permits one cartridge supplier or manufacturer to provide cartridges for that device/manufacturer, while a second cartridge manufacturer, which would otherwise provide compatible cartridges, is denied from supplying compatible cartridges for that manufacturer. In addition, this enables distribution selectivity to certain cartridge manufacturers and suppliers, while maintaining standardization of cartridges to all electronics devices in a field based on other common features (such as fuel type and connector).

Cartridge compatibility and selectivity may be divided by: device type (laptop, cell phone, PDA, portable fuel cell system, etc.), fuel type, device manufacturer, fuel cell type (RMFC, DMFC, SOFC, etc.), fuel cell system type (RMFC, DMFC, SOFC, etc.), business desire such as relationships with quality partners, geographic region such as country, max fuel level, and/or current fuel level and application (i.e. Mil Spec or IEC certification).

Authentication and compatibility also permits cartridge manufacturers in distribution arrangements to control which and whose devices their cartridges operate with. In one embodiment, the cartridge includes a small processor that requires authentication with the device. In this case, compatibility information is selectively provided to one manufacturer of an electronics device (e.g., portable computers and Apple), while a second electronics device manufacturer (e.g., portable computers and Toshiba) is denied form using the cartridges based on its exclusion from the compatibility information (e.g., an encrypted number that selectively enables compatibility but is only known by one manufacturer). This selectivity may occur even though both cartridges include otherwise compatible features such as a connector common to all laptops or a fuel common to all laptops.

Cartridge compatibility may also be dissected based on device. More specifically, only certain devices may be used with cartridges that dictate what devices they provide fuel to. For example, methanol cartridges for laptop computers may include compatibility information that methanol cartridges for cell phones and PDAs do not include.

A digital memory on a cartridge may also specify compatibility options. Instructions stored in the cartridge memory may dictate what devices are suitable for use with the cartridge. For example, the cartridge may include a certain fuel type and the memory informs a probing controller what type of fuel the cartridge contains. The controller then validates if this type of fuel is suitable for use with its device. In another embodiment, the memory includes a list of devices such as laptop computers that the cartridge is permitted to provide fuel to. This is useful when a laptop manufacturer for example includes an older version and a newer version of a fuel cell system in the laptop and the versions require different fuels. The cartridge may then specify which laptop models it is compatible with.

Returning to FIG. 7, compatibility information included on the cartridges is then validated (406). If the authentication does not pass, then the controller on the device denies fuel provision from the cartridge (409). Denial may include not turning on a pump or opening a valve that enables fuel flow from the cartridge to the fuel cell system. If the authentication passes, then the controller permits fuel flow and cartridge usage (410).

The cartridges may be disposable or reusable. Disposable cartridges are discarded when depleted. Refillable cartridges may also be disposed if desired, or brought to a collection site (428). The collection site may locally store fuel in the cartridges, or ship them to another facility for refilling (430).

At this point, compatibility information the cartridges may be updated (back to 424). For example, encryption information, serial numbers, and passwords may be changed. Alternatively, a new digital memory chip may be inserted in place an old chip when the cartridge is refilled. Digital authentication chips that cannot be reprogrammed can be replaced with a new chip. In some instances, single use chips are more cost effective that re-writable chips, and the interface between the cartridge and fuel cell system can be simplified.

In one embodiment, the fuel cartridges are refilled at a qualified and licensed refilling station. Used cartridges may be collected at cartridge sales points and returned to the refilling stations. The refilling station may inspect the cartridge, read the cartridge serial number, and compare the serial number to the cartridge database to determine the number of refills and scrap the cartridge after a set number of refills. The refilling station may then records the refilling event and reprograms the cartridge fuel gauge with the proper increments of fuel.

While this invention has been described in terms of several preferred embodiments, there are alterations, permutations, and equivalents that fall within the scope of this invention which have been omitted for brevity's sake. For example, while fuel cell systems were described with respect to including a regenerator and other system parts, many of these components are not necessary for a fuel cell system and may be omitted from various embodiments. It is understood that the fuel cells need not include one or more heat transfer appendages to benefit from heating transfer techniques described herein. It is therefore intended that the scope of the invention should be determined with reference to the appended claims.

What is claimed is:

1. A method of permitting fuel flow to a device that includes a fuel cell system, the method comprising:
sending a challenge from a processor included with the device to a processor included with a fuel cartridge;
receiving, from the fuel cartridge, an encrypted response to the challenge;
submitting the encrypted response to a validation test;
permitting fuel flow from the fuel cartridge to the fuel cell system when the encrypted response to the challenge passes the validation test; and
denying fuel flow from the fuel cartridge to the fuel cell system when the encrypted response to the challenge does not pass the validation test.

2. The method of claim 1 wherein the challenge includes a random number.

3. The method of claim 1 wherein the challenge includes a request for a password.

4. The method of claim 3 wherein the encrypted response includes an encrypted password.

5. The method of claim 1 wherein the processor on the fuel cartridge uses a cartridge encryption key stored in a digital memory included in the fuel cartridge in the response to the encrypted challenge and the cartridge encryption key is related to a key stored by the device.

6. The method of claim 5 wherein the cartridge encryption key is a function of a) the encryption key stored by the device and b) an identification for the fuel cartridge.

7. The method of claim 1 further comprising, using the device processor, creating a second encrypted response to the challenge using a device encryption key stored in a memory included in the device.

8. The method of claim 1 further comprising mechanically decoupling the cartridge when the encrypted response to the challenge does not pass the validation test.

9. The method of claim 1 further comprising receiving an indication that the fuel cartridge has been coupled to the device that includes the fuel cell system.

10. Logic encoded in one or more tangible media for execution and, when executed, operable to permit fuel flow to a device that includes a fuel cell system, the logic including:
instructions for sending a challenge from a processor included with the device to a processor included with a fuel cartridge;
instructions for receiving, from the fuel cartridge, an encrypted response to the challenge;
instructions for submitting the encrypted response to a validation test;
instructions for permitting fuel flow from the fuel cartridge to the fuel cell system when the encrypted response to the challenge passes the validation test; and
instructions for denying fuel flow from the fuel cartridge to the fuel cell system when the encrypted response to the challenge does not pass the validation test.

11. A method of interfacing a fuel cartridge with a device that includes a fuel cell, the method comprising:
receiving, at a processor on the fuel cartridge, a challenge from a processor included in the device that includes the fuel cell;
responding to the challenge using the processor on the fuel cartridge and an encryption key stored in a memory with the fuel cartridge;
sending an encrypted response to the challenge from the fuel cartridge to the device; and
providing fuel to the device when the encrypted response to the challenge passes a validation test.

12. The method of claim 1 wherein the challenge includes a random number.

13. The method of claim 1 wherein the challenge includes a request for a password.

14. The method of claim 13 wherein the encrypted response includes an encrypted password that is stored in the cartridge memory.

15. The method of claim 1 wherein the processor on the fuel cartridge uses a cartridge encryption key stored in a digital memory included in the fuel cartridge in the response to the encrypted challenge and the cartridge encryption key is related to an encryption key stored by the device.

16. The method of claim 15 wherein the cartridge encryption key is a function of a) the encryption key stored by the device and b) an identification for the fuel cartridge.

17. A portable device for producing electrical energy, the portable device comprising:
a fuel cell;
a mating connector configured to interface with a cartridge connector included in a portable fuel cartridge to permit transfer of fuel from the portable fuel cartridge to the device; and
a device processor, operating according to instructions stored in a memory, configured to
send a challenge from the device processor to a processor included with the fuel cartridge,
receive, from the fuel cartridge, an encrypted response to the challenge,
submit the encrypted response to a validation test,
permit fuel flow from the fuel cartridge to the fuel cell system when the encrypted response to the challenge passes the validation test, and
deny fuel flow from the fuel cartridge to the fuel cell system when the encrypted response to the challenge does not pass the validation test.

18. The portable device of claim 17 further comprising an ejection system configured to at least partially detach the fuel cartridge from the device when the encrypted response to the challenge does not pass the validation test.

19. A portable cartridge for storing a fuel, the portable cartridge comprising:
an internal cavity adapted to contain the fuel;
a cartridge connector configured to couple to a mating connector on a device that includes a fuel cell system;
a memory adapted to store encrypted information or a cartridge encryption key; and
a cartridge processor, operating according to instructions stored in a memory, configured to
receive a challenge from a processor included in the device that includes the fuel cell system,
respond to the challenge using the encrypted information or the cartridge encryption key,
send an encrypted response to the challenge from the fuel cartridge to the device, and
provide fuel to the device when the encrypted response to the challenge passes a validation test.

20. The portable cartridge of claim 19 wherein the challenge includes a random number.

21. The portable cartridge of claim 19 wherein the challenge includes a request for a password.

22. The portable cartridge of claim 21 wherein the encrypted response includes an encrypted password that is stored in the cartridge memory.

23. The portable cartridge of claim 19 wherein the cartridge processor uses a cartridge encryption key stored in a digital memory included in the fuel cartridge in the response to the encrypted challenge and the cartridge encryption key is related to an encryption key stored by the device.

24. The portable cartridge of claim 23 wherein the cartridge encryption key is a function of a) the encryption key stored by the device and b) an identification for the fuel cartridge.

25. A portable cartridge for storing a fuel, the portable cartridge comprising:
a housing that includes an internal cavity;
a bladder in the internal cavity and adapted to contain the fuel;
a cartridge connector configured to couple to a mating connector on a device that includes a fuel cell system;
a memory adapted to store encrypted information or a cartridge encryption key; and
a cartridge processor inside the housing, operating according to instructions stored in a memory, configured to
receive a challenge from a processor included in the device that includes a fuel cell system,
respond to the challenge using the encrypted information or the cartridge encryption key,
send an encrypted response to the challenge from the fuel cartridge to the device, and
provide fuel to the device when the encrypted response to the challenge passes a validation test.

26. The portable cartridge of claim 23 further comprising a communications link extending from the cartridge processor inside the housing to the cartridge connector.
